(19) United States
(12) Patent Application Publication
(10) Pub. No.: US 2009/0323073 A1
(43) Pub. Date: Dec. 31, 2009

(54) Analytical Instrument Having Internal Reference Channel

(75) Inventors: Edward J. Luber, Williamsville, NY (US); Douglas H. Hoover, Corfu, NY (US)

Correspondence Address: HODGSON RUSS LLP;THE GUARANTY BUILDING, 140 PEARL STREET, SUITE 100, BUFFALO, NY, 14202-4040, US

(73) Assignee: REICHERT, INC., Depew, NY (US)

(21) Appl. No.: 12/164,183

(22) Filed: Jun. 30, 2008

(51) Int. Cl. G01N 21/55

(52) U.S. Cl. 356/448

(57) ABSTRACT

An analytical instrument for making measurements based on detection of an SPR resonance minimum or a refractometer transition shadowline on a detector array is improved by configuring a diaphragm of the instruments illumination system to include a first aperture, a second aperture, and an opaque region between the first and second apertures, wherein the opaque region of the diaphragm casts a shadow on the detector array to provide a reference minimum from which a relative location of the resonance minimum or transition shadowline is measurable. By establishing a reference minimum on the detector array as a reference location for relative measurement, the instrument compensates for signal drift and other instrument variations. The diaphragm may include additional apertures and opaque regions for generating additional reference minima over the extent of the detector array.

### FIELD OF THE INVENTION

The present invention relates to analytical instruments for optically measuring a parameter of a test sample by analyzing detector signal information provided by pixels of a light-sensitive detector array, wherein the measurement value depends upon a location of a defining feature of light received by the detector array. The present invention may be applied, for example, to analytical instruments for measuring molecular binding interactions using the principle of surface plasmon resonance (SPR), wherein the defining feature is a resonance minimum (resonance shadow) cast on the detector array. As a further example, the present invention may be applied to critical angle refractometers, wherein the defining feature is a transition “shadowline” between an illuminated region and a darkened region on the detector array.

### BACKGROUND OF THE INVENTION

Snell's law describes what happens when light is directed through a high refractive index prism (e.g. Sapphire—refractive index 1.76) to a surface of the prism in contact with a low refractive index medium, for example a sample fluid. In conventional refractometry, light rays below the critical angle exit the prism bending toward the prism surface, while light rays above the critical angle are totally internally reflected back through the prism. Photons that are totally internally reflected create an electric field at the interface. Here, light is not coming out of the prism, but an electric field extends beyond the reflecting surface. This field oscillates with the usual characteristics of an electromagnetic mode. The electrical component perpendicular to the interface decays exponentially; this is called an evanescent wave. The evanescent wave is bound to the surface.

In critical angle refractometers configured to measure refractive index of a sample, the location of a shadowline corresponding to the critical angle is detected to enable calculation of the sample refractive index.

In SPR spectroscopy instruments, a thin metal layer is added between the prism or slide surface and a fluid compartment contacting the thin metal layer. Free electrons in the metal layer can act as a resonator. Energy for the resonance comes from the evanescent wave produced by the totally internally reflected photons. When certain conditions are met, as determined by the wavelength and angle of incident illumination, and by the refractive indices of the prism, metal and fluid layers, then coupling/resonance occurs between the plasma oscillations of the free electrons in the metal and the bound electromagnetic field of the totally internally reflected photons. This coupling is the result of the momentum of the incoming light equaling the momentum of the plasma electromagnetic field. Photons are “absorbed” and converted to surface plasmons. Because the photons are not reflected, a localized “shadow” occurs in the reflected light and a resonance minimum (resonance shadow) may be detected to measure changes occurring at the surface.

Reichert Inc., assignee of the present invention, currently manufactures SPR instruments that are optically configured to illuminate a spot on a gold layer with rays incident over a range of angles from about 58 to 85 degrees. When the contacting fluid sample is physiological saline solution, the “shadow” or SPR minimum corresponds to light incident to the interface at about 66 degrees. Mass and/or composition changes at the interface between the gold layer and the sample cause changes in the local refractive index near the gold layer, thereby changing the resonance angle. For example, if a protein layer is added to the gold/aqueous interface, then the resonance angle would be about 66.6 degrees, and a sharp dip in reflectivity is observed for this illumination angle.

In Reichert's SR7000 and SR7000DC instruments, the gold surface is illuminated by rays over a range of angles that encompass these shifts in the resonance angle. This range of angles is continuously monitored with a linear photodiode detector array having a plurality of photosensitive pixels each providing a signal indicative of light intensity received thereby. Analysis of the pixel signals determines the illumination angle at which the resonance minimum occurs.

In any given instrument, there is a tendency for signal drift over time due to temperature and light source variations. As a result, the pixel location of the resonance minimum corresponding to a particular illumination angle will change slowly over time, even though the illumination angle and interface chemistry may be the same.

Also, for SPR measurements, the gold layer is typically applied to a removable sensor slide which is coupled to the prism surface by a coupling fluid, such as oil having a known refractive index. This introduces slight variations from measurement to measurement because the coupling fluid layer may not have a uniform thickness for each measurement, such that the sensor slide may be slightly inclined relative to the prism surface to different degrees from measurement to measurement.

These drawbacks reduce the accuracy and repeatability of SPR measurements made by a particular instrument.

Similar drawbacks exist for critical angle refractometers concerning the location of a detected transition shadowline. For example, the AR6 and AR7 series automatic refractometers are subject to signal drift caused by temperature and light source variations.

### SUMMARY OF THE INVENTION

It is therefore an object of the present invention to improve accuracy and repeatability of analytical measurements of the types mentioned above.

An analytical instrument formed in accordance with the present invention generally comprises a measurement interface associated with a test sample; an illumination system for illuminating the measurement interface with light having rays incident to the measurement interface over a range of illumination angles, the illumination system including at least one light source and a diaphragm between the at least one light source and the measurement interface; and a detector array arranged to detect light coming from the measurement interface, the detector array including a plurality of photosensitive pixels each providing a signal indicative of light intensity received thereby.

The invention is characterized in that the diaphragm has a first aperture, a second aperture, and an opaque region between the first and second apertures, such that the opaque region casts a shadow on the detector array to provide a reference minimum in light intensity at a location on the detector array. The location of the reference minimum on the detector array, like the location of an SPR resonance minimum or a critical angle shadowline on the array, is subject to signal drift over time as a result of instrument use. Therefore, the reference minimum may be used as a reference from which a relative location of an SPR resonance minimum or a critical angle shadowline on the detector array may be measured to cancel the effects of signal drift and other variations in the measurement system.

An alternative embodiment of the invention is characterized in that the diaphragm has at least one further aperture spaced from the second aperture to define at least one further opaque region for creating another reference minimum on the detector array. In such an alternative embodiment, signal drift behavior over an extended pixel range that includes the normal measurement range may be evaluated and compensated for in the reported measurement value.

The invention encompasses a method of compensating for signal drift in an analytical instrument having an illumination system for illuminating a measurement interface associated with a test sample. The method generally comprises the steps of configuring the illumination system to cast a shadow on a detector array arranged to detect light coming from the measurement interface, wherein the shadow is located between illuminated regions of the detector array, to provide a reference minimum on the detector array, the location of the reference minimum being subject to signal drift over time as a result of instrument use; and measuring the location of a feature of the detected light relative to the location of the reference minimum.

### BRIEF DESCRIPTION OF THE DRAWING FIGURES

The nature and mode of operation of the present invention will now be more fully described in the following detailed description of the invention taken with the accompanying drawing figures, in which:

FIG. 1 is a schematic side view representation of an analytical instrument known in the prior art;

FIG. 2 is a plan view of a diaphragm used in an illumination system of the prior art instrument shown in FIG. 1;

FIG. 3 is an enlarged view showing an example of a measurement interface configured for SPR measurements;

FIG. 4 shows a detector scan of the prior art instrument of FIG. 1 configured for SPR measurement of a water sample placed on a slide, in which light intensity is plotted as a function of pixel number;

FIG. 5 is a schematic side view representation of an analytical instrument formed and operating in accordance with an embodiment of the present invention;

FIG. 6A is a plan view of a diaphragm used in an illumination system of the instruments shown in FIGS. 5 and 8;

FIG. 6B is a plan view of a diaphragm formed in accordance with an alternative embodiment of the present invention;

FIG. 6C is a plan view of a diaphragm formed in accordance with another alternative embodiment of the present invention;

FIG. 7A shows a detector scan of the instrument of FIG. 5 configured for SPR measurement of a water sample placed on a sensor slide, in which the diaphragm of FIG. 6A is used and light intensity is plotted as a function of pixel number;

FIG. 7B shows a detector scan similar to that shown in FIG. 7A, however the diaphragm of FIG. 6B is used;

FIG. 7C shows a detector scan similar to that shown in FIG. 7A, however the diaphragm of FIG. 6C is used;

FIG. 8 is a schematic side view representation of an analytical instrument formed and operating in accordance with another embodiment of the present invention;

FIG. 9 is an enlarged view showing an example of a measurement interface of the instrument of FIG. 8 configured for critical angle refractometric measurements;

FIG. 10A shows a detector scan of the instrument of FIG. 8 configured for critical angle refractive index measurement of a water sample placed on a slide, in which light intensity is plotted as a function of pixel number; and

FIG. 10B is a scan similar to that of FIG. 10A, however the scan corresponds to a configuration wherein multiple reference minima are generated.

### DETAILED DESCRIPTION OF THE INVENTION

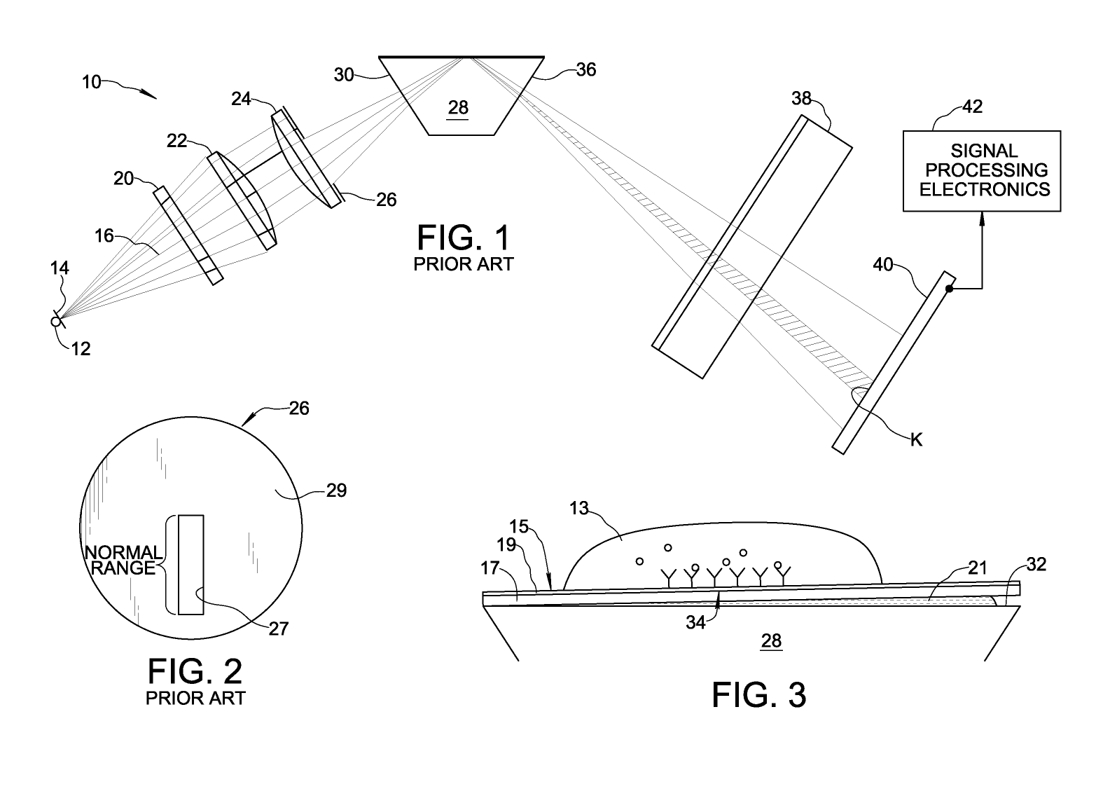

Reference is made initially to FIGS. 1-3 for description of an analytical instrument 10 formed in accordance with the prior art. Analytical instrument 10 comprises a light source 12 illuminating a pinhole aperture 14 for generating an illumination beam 16 propagating along an optical path. Instrument 10 further comprises a polarizer 20 located in the optical path for polarizing illumination beam 16. The polarized illumination beam 16 then passes through a pair of focusing lenses 22, 24 and is thereby converted from a divergent beam to a convergent beam. A diaphragm 26 is positioned in optical path 18 immediately after the second focusing lens 24 to act as a field stop. As shown in FIG. 2, diaphragm 26 includes a single elongated slit aperture 27 surrounded by an opaque region 29. Light transmitted through aperture 27 of diaphragm 26 is received by high-index prism 28 through a light entry surface 30 of the prism. The convergent illumination beam 16 may be focused at a point just below a sample surface 32 of prism 28, such that the beam is once again divergent as it approaches a measurement interface 34 of instrument 10. Alternatively, the convergent beam 16 may be focused at a point somewhere above measurement interface 34. As may be understood, measurement interface 34 may be illuminated with either a divergent or convergent beam, as long as the illumination beam includes rays incident over a range of angles designed to include resonance angles expected to be measured with instrument 10. For example, the range of angles from about 58 to 85 degrees has been found suitable for a variety of measurement applications in the Reichert instruments mentioned above.

FIG. 3 shows a configuration wherein the measurement interface 34 is a surface plasmon resonance (SPR) interface. In this configuration, a sample 13 is applied to a sensor slide 15 having a glass substrate 17 coated with a thin gold layer 19. Sensor slide 15 is coupled to sample surface 32 of prism 28 by a layer of oil 21 having an index of refraction that is less than or equal to the index of refraction of prism 28 and preferably matches the index of refraction of either prism 28 or glass substrate 17. Other configurations may be used to provide an SPR interface in accordance with techniques known to those skilled in the art.

Light reflected from measurement interface 34 leaves prism 28 through exit surface 36 and passes through a cylindrical collection lens 38 before it is received by a detector array 40. Detector array 40 includes a plurality of photosensitive pixels each providing a signal indicative of light intensity received thereby. A linear or two-dimensional solid-state array may be used as detector array 40. The shaded region K in the reflected beam represents a resonance minimum corresponding to a sharp drop in light intensity due to surface plasmon resonance. The pixel signal information from detector array 40 is processed by signal processing electronics 42 to determine the illumination angle at which surface plasmon resonance occurs, thereby providing analytical information about sample 13.

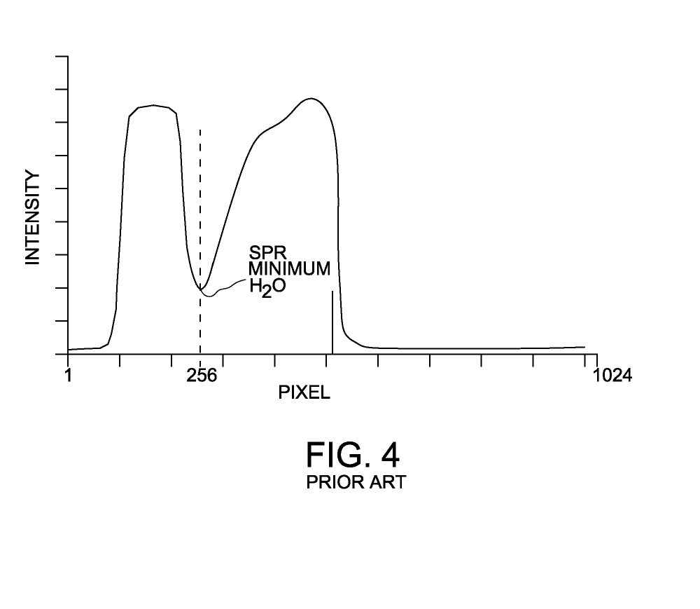

FIG. 4 illustrates a representative scan of detector array 40 for a water sample placed on sensor slide 15. The resonance minimum K is observable graphically in the scan at approximately pixel number 256 along the array. In accordance with the prior art, the pixel number corresponding to resonance minimum K provides an absolute basis for determining the illumination angle at which surface plasmon resonance occurs. Those skilled in the art are aware that various algorithms are available for determining which pixel (or fractional sub-pixel) on detector array 40 corresponds to the location of resonance minimum K. A weighted centroid algorithm is currently preferred for this task.

As mentioned in the background section above, signal drift and small inclination differences of sensor slide 15 may cause instrument 10 to yield varying measurement results when constant measurement results are expected.

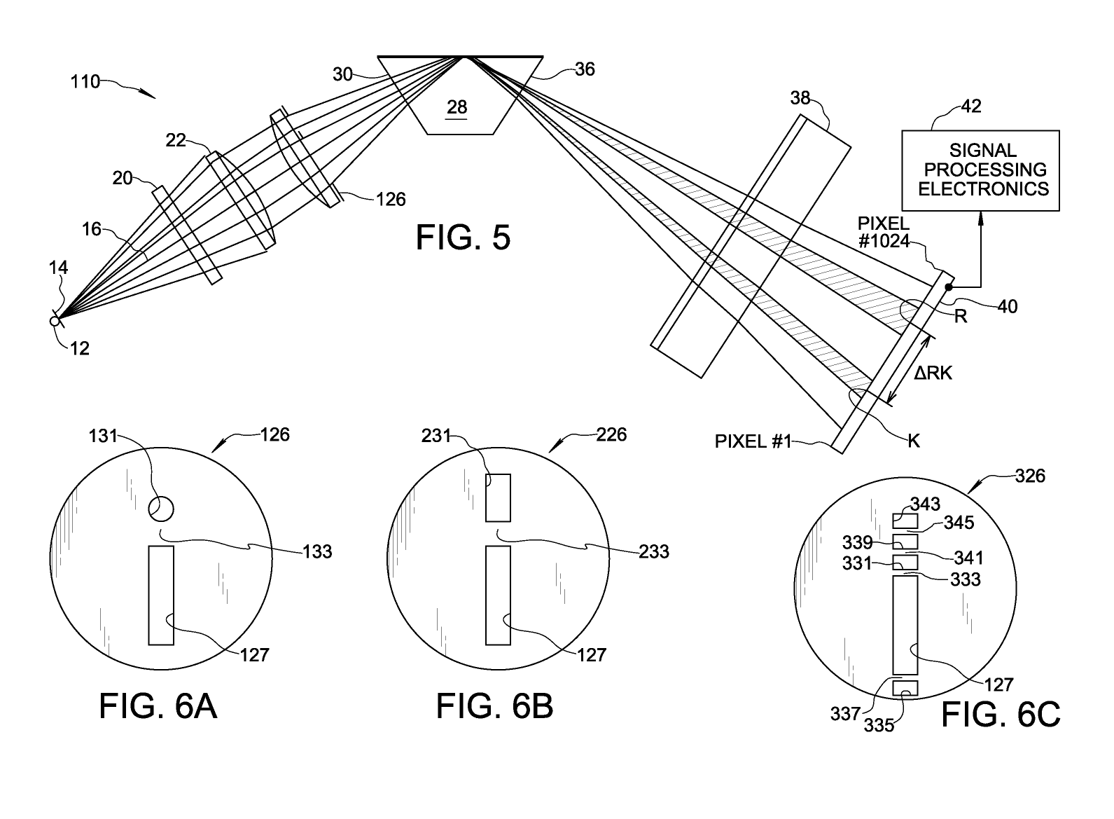

An analytical instrument 110 formed in accordance with an embodiment of the present invention is shown in FIG. 5, and is operating with an SPR configuration as illustrated in FIG. 3. Instrument 1 10 is largely similar to instrument 10 of the prior art, but comprises a diaphragm 126 that differs from diaphragm 26 depicted in FIG. 2. Diaphragm 126 is shown in FIG. 6A as including a first aperture 127 which may be in the form of an elongated slit similar to aperture 27 of diaphragm 26, a second aperture 131 which may be in the form of a circular hole or other geometric shape, and an opaque region 133 between first aperture 127 and second aperture 131. As used herein, the term “aperture” refers to a light-transmitting region, and may be embodied by open space or by light-transmitting material. Second aperture 131 may be shorter in length than first aperture 127. Opaque region 133 casts a shadow on detector array 40 to provide a reference minimum R in light intensity at a pixel location on the detector array. Apertures 127 and 131 may be designed such that first aperture 127 transmits rays incident to the measurement interface at angles within the range of illumination angles in which the resonance angle (or critical angle, in the case of refractometric measurement) is expected to be found, and second aperture 131 transmits rays incident to the measurement interface at angles outside this range of illumination angles.

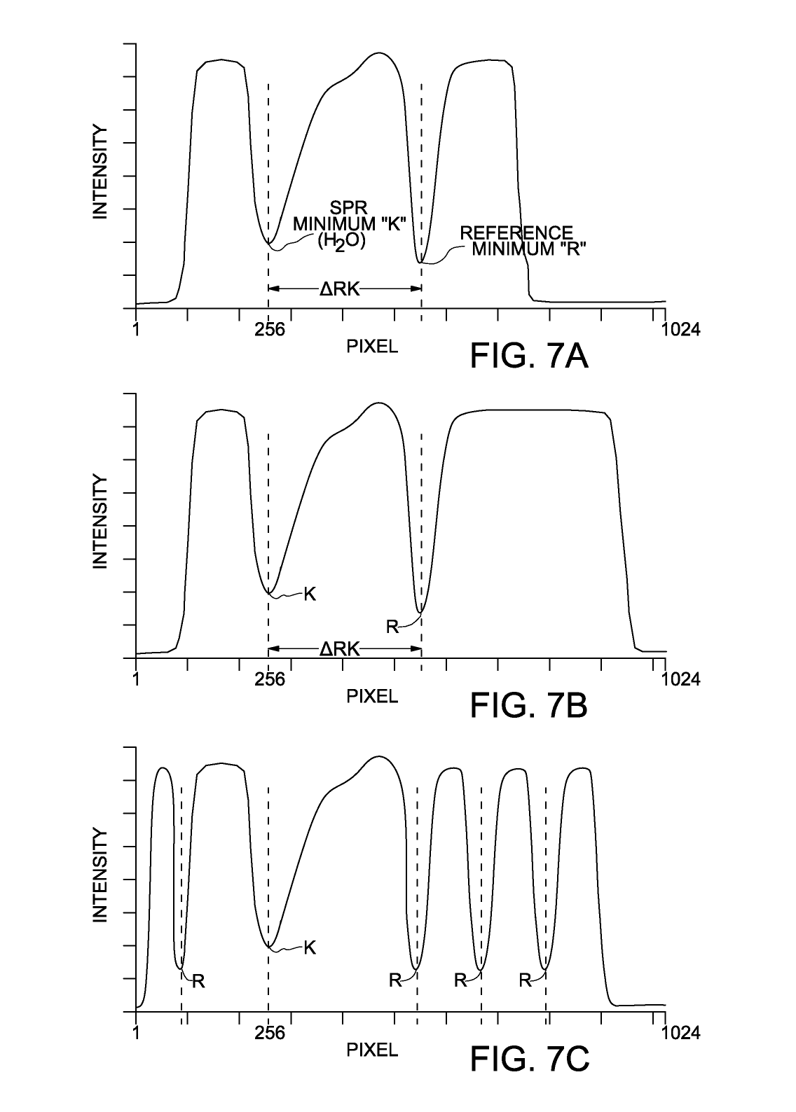

FIG. 7A shows a scan of detector array 40 of instrument 110 depicted in FIG. 5 wherein diaphragm 126 of FIG. 6A is used. Instrument 110 is configured for SPR measurement of a water sample placed on a sensor slide. The pixel locations of resonance minimum K and reference minimum R are indicated. The pixel location of resonance minimum K relative to reference minimum R is indicated by the difference ARK in FIGS. 5 and 7A.

As may be understood, the absolute pixel location of reference minimum R is subject to the same fluctuations as the absolute pixel location of resonance minimum K resulting from signal drift over time and differences in sensor slide inclination related to the coupling fluid layer 21. In accordance with the present invention, the pixel location of resonance minimum K may be determined relative to the pixel location of reference minimum R. The pixel location of resonance minimum K relative to reference minimum R is substantially constant over time for a given sample because the absolute locations of K and R are subject to the same signal drift and system fluctuations. Thus, by configuring diaphragm 126 to provide reference minimum R at a previously unused portion of detector array 40, relative measurement of resonance minimum K is possible so that signal drift is canceled out. The absolute pixel location of reference minimum R, to which the absolute pixel location of resonance minimum K may be compared for relative measurement, may be determined using the same algorithm used to determine the absolute pixel location of resonance minimum K, or using a different algorithm.

An alternative embodiment may be realized by substituting modified diaphragm 226 shown in FIG. 6B for diaphragm 126 shown in FIG. 6A. Diaphragm 226 has a second aperture 231 that is shaped as a rectangle rather than a circle, and is separated from first aperture 127 by an opaque region 233. FIG. 7B shows a representative scan where diaphragm 226 is used in place of diaphragm 126.

Another alternative embodiment may be realized by substituting modified diaphragm 326 shown in FIG. 6C for diaphragm 126 shown in FIG. 6A. Diaphragm 326 has a second aperture 331, a third aperture 335 positioned such that first aperture 127 is between second aperture 331 and third apertures 335, a fourth aperture 339, and a fifth aperture 343. The apertures are spaced apart by opaque regions 333, 337, 341, and 345 as shown in FIG. 6C. FIG. 7C shows a representative scan where diaphragm 326 is used in place of diaphragm 126. As is apparent, a plurality of reference minima R are generated, one in a lower pixel number region before the measurement region containing resonance minimum K and three in a higher pixel number region after the measurement region containing resonance minimum K. Where multiple reference minima are generated, signal drift behavior over the entire scanned array may be evaluated to indicate localized signal drift effects, whereby appropriate signal drift compensation may be applied to a given measurement. For example, a linear or non-linear compensation function may be determined and applied to each measurement.

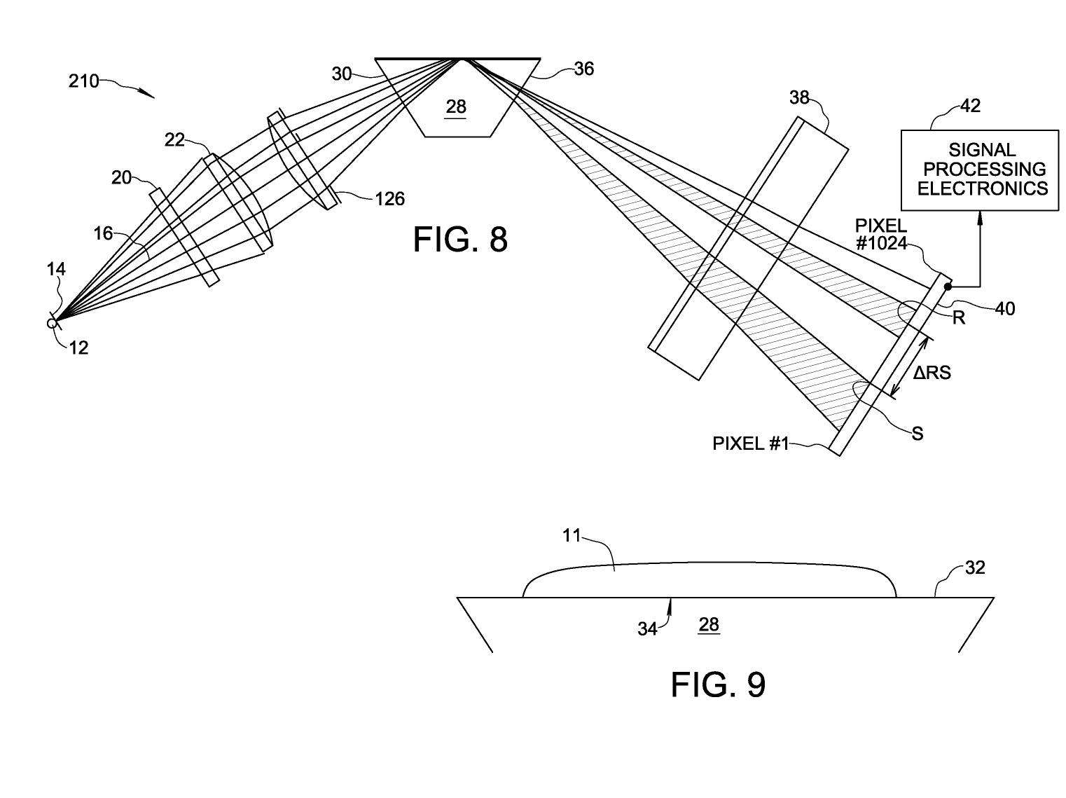

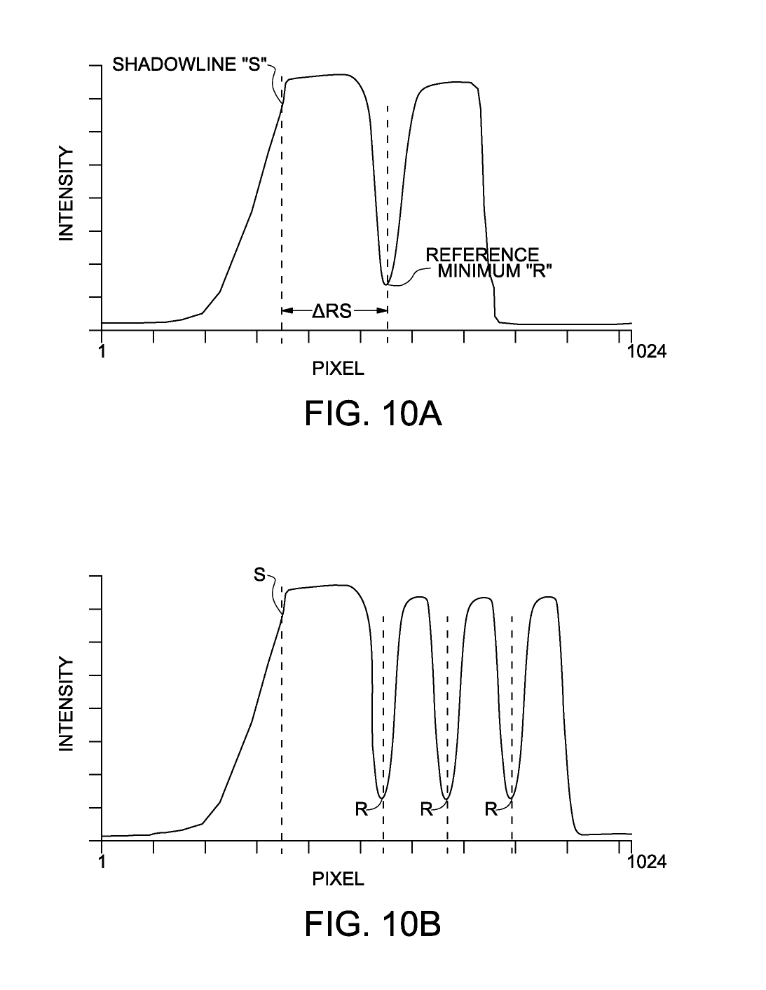

FIG. 8 shows an instrument 210 that is substantially similar to instrument 110, but is configured as shown in FIG. 9 for critical angle refractive index measurement of a sample 11 placed directly on sample surface 32 of prism 28. A scan of detector array 40 is provided in FIG. 10A for a measured water sample. Illumination impinging upon detector array 40 is characterized by a transition shadowline S between an illuminated region and a darkened region, wherein the pixel location of shadowline S is dependent upon the refractive index of sample 11. In accordance with the present invention, the pixel location of shadowline S may be measured relative to reference minimum R to reduce the influence of signal drift and other systemic variations on the measurement. The relative pixel location of shadowline S is labeled ΔRS in FIGS. 8 and 10A. FIG. 10B shows a representative scan similar to that of FIG. 10A, wherein the illumination configuration is altered by replacing diaphragm 126 in FIG. 8 with a diaphragm 326 formed in accordance with FIG. 6C to provide a plurality of reference minima.

The present invention may be implemented in Reichert's SR7000 or SR7000DC SPR spectrometer, or in Reichert's AR6 and AR7 series automatic refractometers, by modifying the existing diaphragm to provide an additional aperture, and by programming the processing software to determine the pixel location of the reference minimum and measure the pixel location of the resonance minimum relative to the reference minimum or transition shadowline, as the case may be.

While not depicted in the drawing views, it is contemplated to provide a dual channel illumination system whereby two separate illumination spots are formed side-by-side at measurement interface 34 and detected on a pair of side-by-side detector arrays.

What is claimed is:

1. An analytical instrument comprising:
a measurement interface associated with a test sample;
an illumination system for illuminating the measurement interface with light having rays incident to the measurement interface over a range of illumination angles, the illumination system including at least one light source and a diaphragm between the at least one light source and the measurement interface; and
a detector array arranged to detect light coming from the measurement interface, the detector array including a plurality of photosensitive pixels each providing a signal indicative of light intensity received thereby;
wherein the diaphragm has a first aperture, a second aperture, and an opaque region between the first and second apertures, the opaque region casting a shadow on the detector array to provide a reference minimum in light intensity at a location on the detector array, the location of the reference minimum being subject to signal drift over time as a result of instrument use.

2. The analytical instrument according to claim 1, wherein the measurement interface is a surface plasmon resonance interface, and the detected light exhibits a resonance minimum

3. The analytical instrument according to claim 1, wherein the measurement interface is a critical angle refractometer interface, and the feature of the detected light is a transition shadowline between an illuminated region and a darkened region.

4. The analytical instrument according to claim 1, wherein the first aperture transmits rays incident to the measurement interface at angles within the range of illumination angles, and the second aperture transmits rays incident to the measurement interface at angles outside the range of illumination angles.

5. The analytical instrument according to claim 1, wherein the first aperture is shaped as an elongated slit and the second aperture is shorter in length than the first aperture.

6. The analytical instrument according to claim 5, wherein the second aperture is shaped as a circle.

7. The analytical instrument according to claim 5, wherein the second aperture is shaped as a rectangle.

8. The analytical instrument according to claim 1, further comprising at least one additional aperture and at least one additional opaque region between the second aperture and the at least one additional aperture, the at least one additional opaque region providing at least one additional reference minimum on the detector array.

9. The analytical instrument according to claim 8, wherein the at least one additional aperture includes a third aperture, and the first aperture is between the second aperture and the third aperture.

10. The analytical instrument according to claim 9, wherein the at least one additional aperture includes a fourth aperture, and the first aperture and second aperture are between the third aperture and the fourth aperture.

11. A method of compensating for signal drift in an analytical instrument having an illumination system for illuminating a measurement interface associated with a test sample, the method comprising the steps of:
configuring the illumination system to cast at least one shadow on a detector array arranged to detect light coming from the measurement interface, wherein the shadow is located between illuminated regions of the detector array, to provide at least one corresponding reference minimum on the detector array, a location of the reference minimum being subject to signal drift over time as a result of instrument use;
measuring the location of the at least one reference minimum on the detector array and a location of a feature of the detected light related to an analytical measurement; and
using the location of the at least one reference minimum to correct for signal drift error in the location of the feature related to the analytical measurement.

12. The method according to claim 11, wherein the feature related to the analytical measurement is a resonance minimum resulting from surface plasmon resonance at the measurement interface.

13. The method according to claim 1 1, wherein the feature related to the analytical measurement is a transition shadowline between an illuminated region and a darkened region resulting from a critical angle of total internal reflection at the measurement interface.

14. The method according to claim 11, wherein the at least one reference minimum includes a plurality of reference minima.

15. In an analytical instrument for making measurements based on detection of a resonance minimum on a detector array, the resonance minimum resulting from surface plasmon resonance at an illuminated measurement interface, the improvement comprising:
a diaphragm including a first aperture, a second aperture, and an opaque region between the first and second apertures, wherein the opaque region of the diaphragm casts a shadow on the detector array to provide a reference minimum.

16. The improvement according to claim 15, wherein the diaphragm includes at least one additional aperture separated from either the first aperture or the second aperture by an additional opaque region, wherein the additional opaque region of the diaphragm casts a shadow on the detector array to provide an additional reference minimum.

17. In an analytical instrument for making measurements based on detection of a transition shadowline on a detector array, the transition shadowline resulting from critical angle reflection at an illuminated measurement interface, the improvement comprising:
a diaphragm including a first aperture, a second aperture, and an opaque region between the first and second apertures, wherein the opaque region of the diaphragm casts a shadow on the detector array to provide a reference minimum.

18. The improvement according to claim 17, wherein the diaphragm includes at least one additional aperture separated from either the first aperture or the second aperture by an additional opaque region, wherein the additional opaque region of the diaphragm casts a shadow on the detector array to provide an additional reference minimum.
